(19) United States
(12) Patent Application Publication
(10) Pub. No.: US 2019/0004487 A1
(43) Pub. Date: Jan. 3, 2019

(54) MOBILITY ROOM, MOBILITY ROOM MANAGEMENT SYSTEM, MANAGEMENT SERVER, AND BUILDING MANAGEMENT SYSTEM

(71) Applicant: HONDA MOTOR CO., LTD., Tokyo (JP)

(72) Inventors: Makoto Yuzawa, Wako-shi (JP); Atsushi Nishi, Wako-shi (JP); Miyuki Shimota, Wako-shi (JP); Takaichi Sano, Wako-shi (JP); Keiichi Iguchi, Minato-ku (JP); Seiichi Yamamoto, Tokyo (JP)

(21) Appl. No.: 16/015,223

(22) Filed: Jun. 22, 2018

(30) Foreign Application Priority Data
Jun. 28, 2017 (JP) 2017-126274

(51) Int. Cl. G05B 15/02; G06Q 30/04

(52) U.S. Cl. CPC G05B 15/02; G06Q 30/04

(57) ABSTRACT

A mobility room includes a coupling part configured to couple an inside of a room main body and an inside of a building or another moving object to enable a user to move; and a movement control unit configured to move the room main body autonomously by means of the movement device to cause the coupling part to reach a target coupling position with respect to the building or the other moving object on the basis of a first movement request input to an operation input device provided to the room main body or a second movement request received from an external device through a communication device.

### CROSS-REFERENCE TO RELATED APPLICATION

This application is based upon and claims the benefit of priority from Japanese Patent Application No. 2017-126274 filed on Jun. 28, 2017, the contents of which are incorporated herein by reference.

### BACKGROUND OF THE INVENTION

### Field of the Invention

The present invention relates to a mobility room, a mobility room management system, a management server, and a building management system.

### Description of the Related Art

An object of Japanese Laid-Open Patent Publication No. 2001-271500 is to provide a house that enables a person in a wheelchair to get on and out of an automobile easily ([0004], Abstract). In order to achieve the object, in the above publication (Abstract), a floor 4A of a house 1 is a flat floor without a step that can be an obstacle to movement of a person 5 who is physically challenged or an elderly person. An outer wall surface 6 of the house 1 is provided with an opening 7. The floor 4A connected to the opening 7 is provided with the height of the floor 4A corresponding to the height of a floor 22 of an automobile 20.

Thus, a step is not produced in a boundary portion between the floor 4A in the room and the floor 22 of the automobile 20, so that a flat floor without a step, that is, a so-called barrier-free floor extends from the room to the automobile 20. As a result, a complete barrier-free floor where a person in a wheelchair 5A can get on and out of the automobile 20 by her/himself without any help of another person and there is no obstacle to movement for the person in the wheelchair 5A is formed in the house 1. The person in the wheelchair 5A easily gets on and out of the automobile 20.

### SUMMARY OF THE INVENTION

In the above publication, a step is not produced in the boundary portion between the floor 4A in the room and the floor 22 of the automobile 20, so that the flat floor without a step, that is, the so-called barrier-free floor can be formed not only within the room but continuously to the automobile 20. However, the above publication does not describe how the automobile 20 is parked, and it seems that the automobile 20 is maneuvered manually. In some cases, aligning (or connecting) the floor 4A in the room and the floor 22 of the automobile 20 will be relatively difficult.

The problem above also applies to a case in which a vehicle other than the automobile or a moving object and a building are coupled or a case in which a plurality of moving objects is coupled.

The present invention has been made in view of such a problem, and an object is to provide a mobility room, a mobility room management system, a management server, and a building management system that can easily perform the coupling and the like.

A mobility room according to the present invention includes: a room main body configured to form a living space; a movement device configured to move the room main body freely; a coupling part configured to couple an inside of the room main body and an inside of a building or another moving object to enable a user to move; and a movement control unit configured to move the room main body autonomously by means of the movement device to cause the coupling part to reach a target coupling position with respect to the building or the another moving object on the basis of a first movement request input to an operation input device provided to the room main body or a second movement request received from an external device through a communication device.

In the present invention, the mobility room autonomously moves to cause the coupling part of the mobility room to reach the target coupling position with respect to the building or the another moving object on the basis of the first movement request from the user in the room main body or the second movement request from the external device. This enables the coupling part of the mobility room to easily reach the target coupling position with respect to the building or the another moving object.

The mobility room may further include a fee calculation device configured to calculate a fee for using the mobility room for the user on the basis of a movement distance of the mobility room or a connection time between the mobility room and the building or the another moving object, and to charge the user the fee, display the fee on a display device, or transmit the fee to the external server through the communication device. This enables an easy calculation of the fee for using the mobility room.

The mobility room may further include: an identification information acquisition unit configured to acquire user identification information that is information for identifying the user; a room communication unit configured to be able to communicate with the external device; and a use possible/impossible determination unit configured to determine whether to allow use of the mobility room. The use possible/impossible determination unit may be configured to transmit to the external device through the room communication unit, the user identification information acquired by the identification information acquisition unit and a payment status information request that requests payment status information regarding a payment status of the user. Further, the use possible/impossible determination unit may be configured to acquire the payment status information on the user indicated by the user identification information from the external device through the room communication unit. Furthermore, the use possible/impossible determination unit may be configured to forbid the user to use the mobility room if the payment status information indicates that payment of the fee is overdue. This enables to urge the user to pay the fee.

A mobility room management system according to the present invention includes: a plurality of mobility rooms configured to be able to move autonomously; and a management server configured to control the plurality of mobility rooms on the basis of use requests for using the mobility rooms received from a plurality of external terminals, and the mobility rooms each includes: a room main body configured to form a living space; a movement device configured to move the room main body freely; a connection part configured to connect between an inside of the room main body and an inside of a building or another moving object to enable a movement of a user; and a movement control unit configured to move the room main body autonomously by means of the movement device to cause the coupling part to reach a target coupling position with respect to the building or the another moving object on the basis of a movement request received from the management server.

In the present invention, the mobility room autonomously moves to cause the coupling part of the mobility room to reach the target coupling position with respect to the building or the another moving object on the basis of the use request from the management server. This enables the coupling part of the mobility room to easily reach the target coupling position to the building or the another moving object.

In addition, the management server controls the plurality of mobility rooms; thus, the mobility rooms can be managed effectively.

The mobility room management system may further include a charge device configured to calculate a fee for using the mobility room for the user on the basis of a movement distance of the mobility room or a connection time between the mobility room and the building or the another moving object, and to charge the user the fee. This enables to charge the user the fee of the mobility room easily.

The mobility room management system may further include a payment status database configured to manage a payment status of the fee of each user. When accepting the use request from the external terminal, the management server may be configured to acquire user identification information, to check the payment status of the fee indicated by the user identification information, and refuse the movement request if payment of the fee is overdue. This enables to urge the user to pay the fee.

A management server according to the present invention is configured to manage a plurality of mobility rooms configured to be able to move autonomously, and the management server includes: a server communication unit configured to be able to communicate with an outside; a room controller configured to control the plurality of mobility rooms; and a room database configured to store data of the plurality of mobility rooms. The room controller is configured to receive use requests for using the mobility rooms from a plurality of external terminals through the server communication unit, to select the mobility room that matches a use request by using the room database, and to transmit through the server communication unit a use instruction that corresponds to the use request, to a target mobility room which is the selected mobility room.

The use instruction may include, for example, permission condition information regarding conditions for permitting the use of the target mobility room. Further, the use instruction may include an unlock instruction that instructs the unlocking of the target mobility room. Furthermore, the use instruction may include target coupling position information regarding the target coupling position of the target mobility room.

In the present invention, the use instructions that correspond to the use requests are transmitted to the target mobility rooms that match the use requests received from the plurality of external terminals. This enables to use the plurality of mobility rooms suitably.

A building management system according to the present invention includes: a moving object side coupling part configured to communicate with an inside of a mobility room through a room side coupling part of the mobility room and to enable a user to come and go; and a charge device configured to calculate a fee in accordance with a connection time between the room side coupling part and the moving object side coupling part, and to charge the user the fee.

In the present invention, the fee in proportion to the connection time between the room side coupling unit and the building side coupling unit can be charged.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic structural diagram of a vehicle management system as a mobility room management system according to a first embodiment of the present invention;

FIG. 2 is a plane view that illustrates a case in which a vehicle is coupled to a house in the first embodiment;

FIG. 3 is a flowchart that schematically represents a process at the time when the use of the vehicle starts in the first embodiment;

FIG. 4 is a flowchart that schematically represents a process during the use of the vehicle and at the time when the use of the vehicle ends in the first embodiment;

FIG. 5 is a flowchart of an automatic coupling control in the first embodiment;

FIG. 6 is a flowchart of a coupling assist control in the first embodiment;

FIG. 7 is a flowchart that schematically represents a use end process (an end-of-use process which is a process performed at the time when the use of the vehicle ends) in the first embodiment (detail of S25 in FIG. 4);

FIG. 8 is a schematic structural diagram of a vehicle management system as a mobility room management system according to a second embodiment of the present invention;

FIG. 9 is a first flowchart that schematically represents a reservation process in the second embodiment;

FIG. 10 is a second flowchart that schematically represents the reservation process in the second embodiment;

FIG. 11 is a flowchart that schematically represents a process in a management server at time of the use ends in the second embodiment;

FIG. 12 is a schematic structural diagram of a trailer room management system as a building management system (or mobility room management system) according to a third embodiment of the present invention;

FIG. 13 is a side view expressing a coupling state between a vehicle and a trailer room included in the trailer room management system as the mobility room management system according to the third embodiment;

FIG. 14 is a flowchart that schematically represents a process at the time of a reservation of and a preparation for the use of the trailer room in the third embodiment; and

FIG. 15 is a flowchart that schematically represents a process at the time of the use of the trailer room in a modified example.

### DESCRIPTION OF THE PREFERRED EMBODIMENTS

### A. First Embodiment

### A-1. Structure

### [A-1-1. Overview]

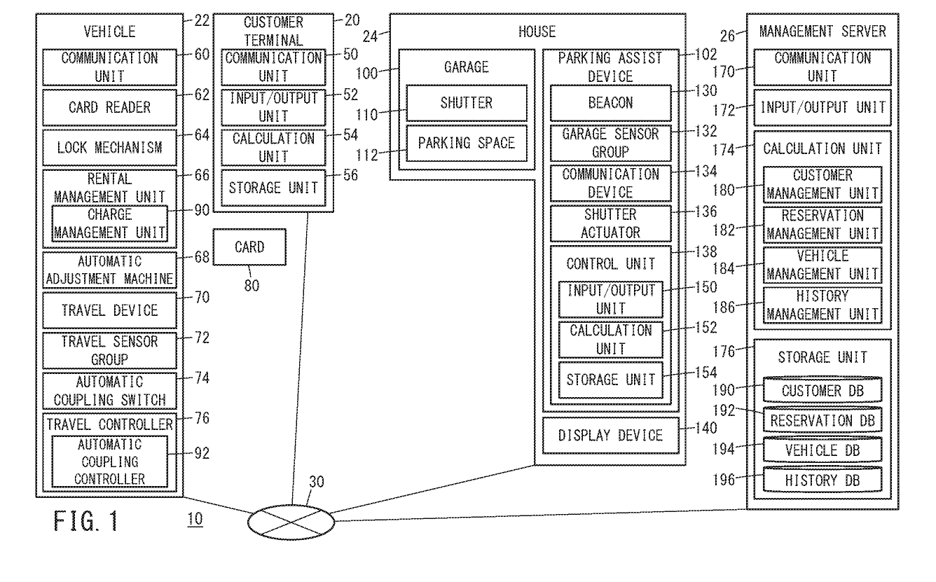

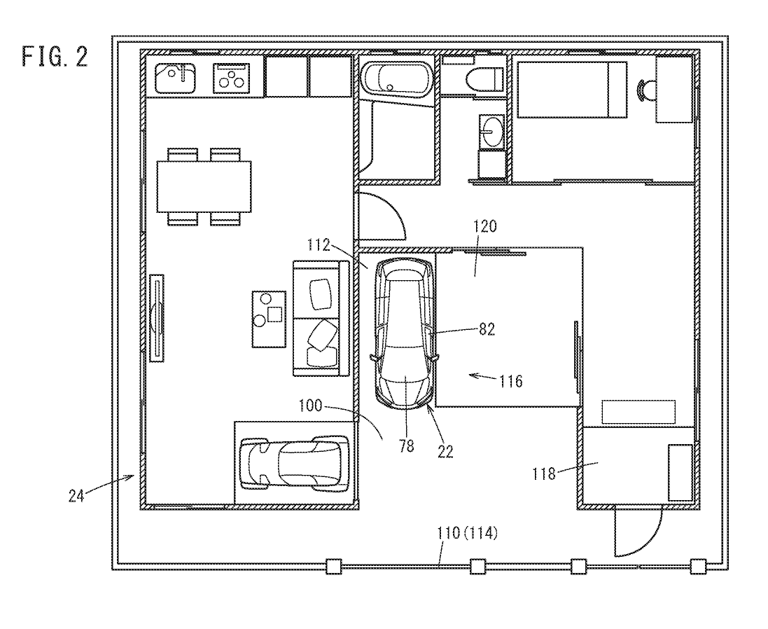

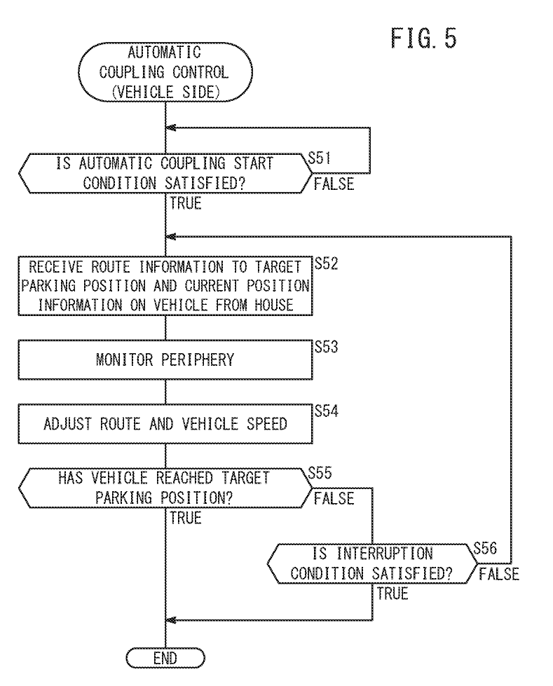

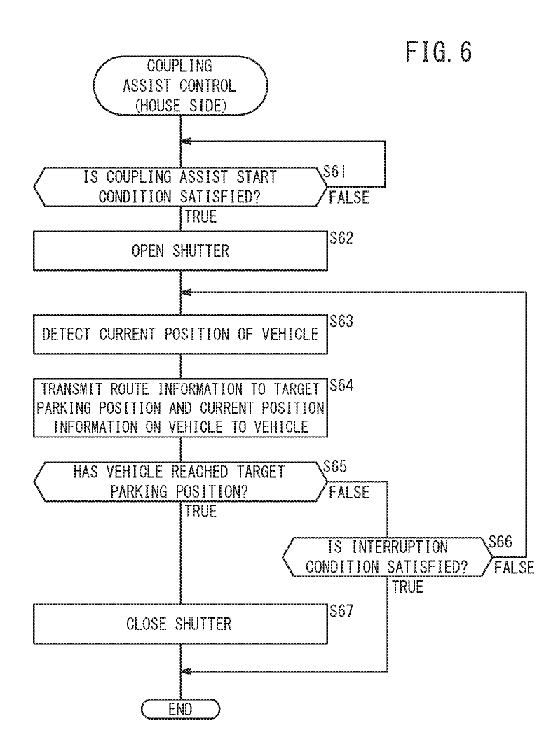

FIG. 1 is a schematic structure diagram of a vehicle management system 10 (hereinafter, also referred to as management system 10 or system 10) as a mobility room management system according to a first embodiment of the present invention. The management system 10 includes a plurality of customer terminals 20, a plurality of vehicles 22, a plurality of houses 24, and a management server 26. In the system 10, the vehicles 22 are rented to the customers (hereinafter, “customers C”) through the management server 26. In other words, the vehicle 22 is a rental car. Alternatively, the vehicle 22 may be a vehicle owned by the customer C. The vehicle 22 can be coupled to the house 24 of the customer C (detailed description will be made with reference to FIG. 2, FIG. 5, and FIG. 6).

The customer terminals 20, the vehicles 22, the houses 24, and the management server 26 can communicate with each other through a communication network 30 (hereinafter, also referred to as network 30). The network 30 is, for example, the Internet. Note that FIG. 1 illustrates one customer terminal 20, one vehicle 22, and one house 24. Moreover, a plurality of management servers 26 may be provided.

### [A-1-2. Customer Terminal 20]

The customer terminals 20 (hereinafter, also referred to as terminals 20) are owned by the customers C and used for reserving the vehicle 22, for example. The terminal 20 includes a communication unit 50, an input/output unit 52, a calculation unit 54, and a storage unit 56. As the terminal 20, a personal computer or a smartphone can be used, for example.

The communication unit 50 performs the input/output of signals from/to the management server 26 and the like. The input/output unit 52 performs the input/output between the customer C (member) and the customer terminal 20. In other words, the input/output unit 52 is a human machine interface (HMI). When the terminal 20 is a personal computer, the input/output unit 52 includes, for example, a keyboard, a mouse, and a display device (none of them are shown). When the terminal 20 is a smartphone, the input/output unit 52 includes, for example, a touch panel (not shown).

The calculation unit 54 includes a central processing unit (CPU) and controls each part of the terminal 20 by executing programs stored in the storage unit 56. For example, the calculation unit 54 communicates with the management server 26 through the communication unit 50 and exchanges various information regarding the rental of the vehicle 22 with the management server 26.

The storage unit 56 stores programs and data to be used by the calculation unit 54 and includes random access memory (hereinafter, referred to as RAM). As the RAM, volatile memory such as a register and non-volatile memory such as flash memory can be used. In addition to the RAM, the storage unit 56 may include read only memory (hereinafter, referred to as ROM).

### [A-1-3. Vehicle 22]

### (A-1-3-1. Overview of Vehicle 22)

FIG. 2 is a plane view that illustrates a case in which the vehicle 22 is coupled to the house 24 in the first embodiment. As illustrated in FIG. 2, the vehicle 22 can be coupled to the house 24. The vehicle 22 according to the first embodiment is an electric vehicle in a narrow sense that travels on energy of only a battery that is not shown (battery electric vehicle). Alternatively, the vehicle 22 may be another kind of vehicle (for example, hybrid vehicle).

As illustrated in FIG. 1, the vehicle 22 includes a communication unit 60, a card reader 62, a lock mechanism 64, a rental management unit 66, an automatic adjustment machine 68, a travel device 70, a travel sensor group (travel sensors) 72, an automatic coupling switch 74, and a travel controller 76. The communication unit 60 (room communication unit) performs the input/output of signals with the house 24 or the management server 26.

The card reader 62 (identification information acquisition unit) reads authentication information Iid (user identification information) from an authentication card 80 (hereinafter, also referred to as card 80) owned by the customer C. The card 80 according to the first embodiment can be a driver's license that includes an integrated circuit (IC), for example. The card reader 62 according to the first embodiment is fixed to a specific part of the vehicle 22 (for example, below rear window) and provided to each vehicle 22. The lock mechanism 64 automatically unlocks and locks a door lock which is not shown.

### (A-1-3-2. Rental Management Unit 66)

The rental management unit 66 (movement management unit) manages the rental of the vehicle 22, and includes an input/output unit, a calculation unit, and a storage unit which are not shown. The input/output unit of the rental management unit 66 performs the input/output between the customer C (member) and the vehicle 22. In other words, the input/output unit is an HMI. The input/output unit includes, for example, a touch panel or a button which is not shown.

The calculation unit of the rental management unit 66 includes a CPU and controls each part of the vehicle 22 by executing programs stored in the storage unit. The calculation unit controls each part regarding the rental and the return of the vehicle 22 by executing programs stored in the storage unit of the rental management unit 66. For example, the calculation unit transmits to the management server 26 through the communication unit 60 information of the customer C read through the card reader 62 at the start of using the vehicle 22. The management server 26 that has received the information of the customer C determines whether there is reservation information Ire regarding the customer C. Then, if there is the reservation information Ire, the management server 26 transmits an unlock instruction to the calculation unit of the rental management unit 66. The calculation unit that has received the unlock instruction causes the lock mechanism 64 to perform an unlocking operation.

The calculation unit of the rental management unit 66 communicates with the management server 26 through the communication unit 60 and exchanges various information regarding the rental of the vehicle 22 (including detected values of the travel sensor group 72) with the management server 26. Moreover, the calculation unit causes the lock mechanism 64 to perform the unlocking or locking operation in accordance with the instructions from the management server 26.

The calculation unit of the rental management unit 66 further includes a charge management unit 90 that manages a charge. The charge management unit 90 manages the charge of a usage fee Fch for the vehicle 22 for a user.

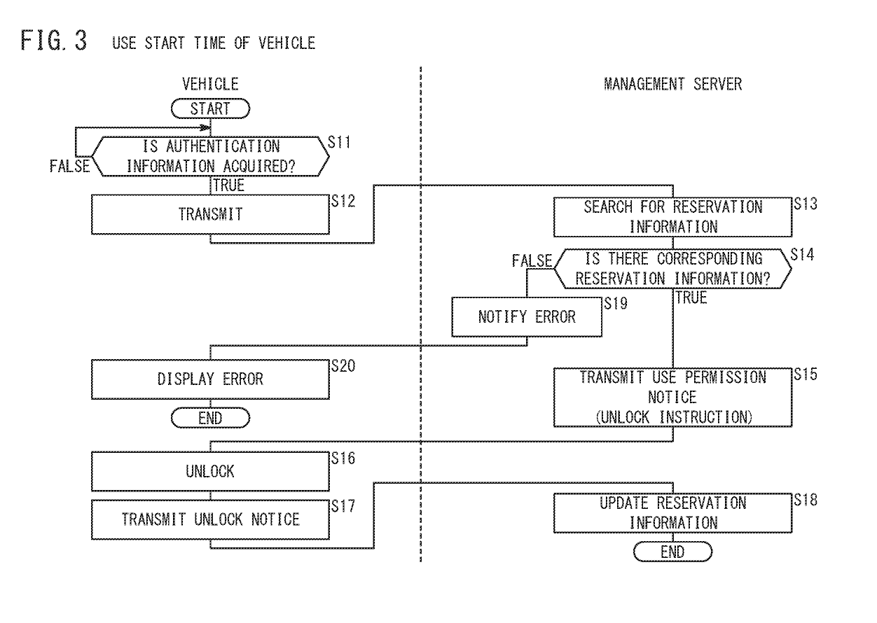

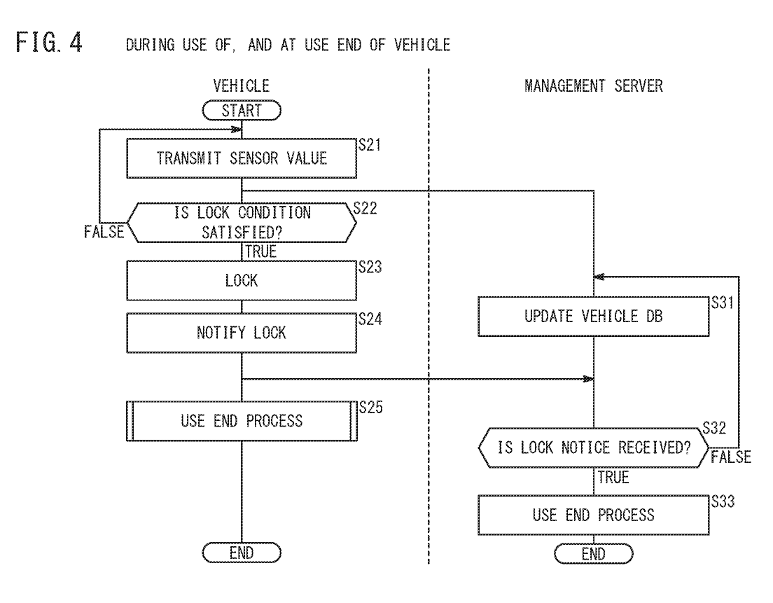

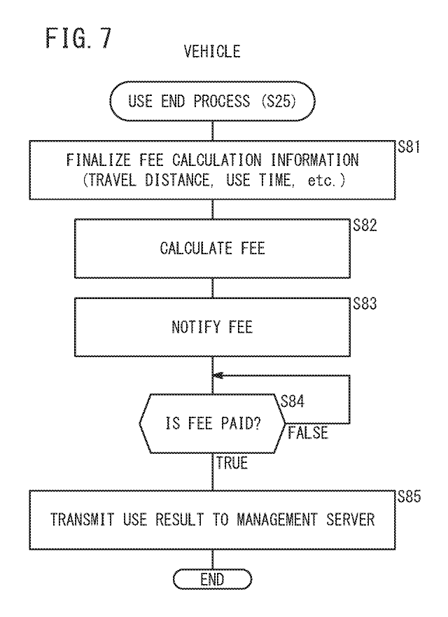

Description will hereinafter be made of a process of the calculation unit of the rental management unit 66 with reference to FIG. 3, FIG. 4, and FIG. 7.

The storage unit of the rental management unit 66 stores programs and data to be used by the calculation unit and includes a RAM. In addition to the RAM, the storage unit may include a ROM.

### (A-1-3-3. Automatic Adjustment Machine 68)

The automatic adjustment machine (self-payment machine) 68 is used for payment of the usage fee Fch for the use of the vehicle 22 and receives cash as the payment of the usage fee Fch and returns the change. It is assumed here in the first embodiment that the automatic adjustment machine 68 accepts cash only, but may be able to deal with other methods of payment. The methods of payment other than cash include, for example, payment by credit card and by electronic money.

### (A-1-3-4. Travel Device 70)

The travel device 70 causes the vehicle 22 to travel and includes a driving device, a braking device, and a steering device which are not shown. The driving device generates a travel driving force of the vehicle 22 and includes a travel motor. The braking device generates a braking force of the vehicle 22 and includes a friction-type braking device. If the vehicle 22 is decelerated by converting kinetic energy into power with the travel motor, the braking device may include the travel motor. The steering device controls the steering of the vehicle 22 and includes, for example, a steering wheel or an electric power steering (EPS) motor.

### (A-1-3-5. Travel Sensor Group 72)

The travel sensor group 72 includes a plurality of sensors used for the travel of the vehicle 22. Here, the sensors include, for example, a vehicle speed sensor, an accelerator operating amount sensor, a brake operating amount sensor, and a steering angle sensor. If the vehicle 22 performs a travel assist or an automatic driving, the travel sensor group 72 includes a peripheral camera, a front radar, a global positioning system device (GPS device), and the like.

### (A-1-3-6. Automatic Coupling Switch 74)

The automatic coupling switch 74 is a switch that instructs the travel controller 76 to perform an automatic coupling control (described below) and is provided in a vehicle compartment 78 (FIG. 2) (for example, near the driver's seat).

### (A-1-3-7. Travel Controller 76)

The travel controller 76 controls the travel of the vehicle 22 by operating the travel device 70 selectively on the basis of the detected values or the like of the travel sensor group 72. The travel controller 76 includes an input/output unit, a calculation unit, and a storage unit which are not shown. The input/output unit of the travel controller 76 performs the input/output between the travel device 70, the travel sensor group 72, and the like.

The calculation unit of the travel controller 76 includes a CPU and controls the travel device 70 by using programs and data that are stored in the storage unit. The calculation unit includes an automatic coupling controller 92. The automatic coupling controller 92 performs an automatic coupling control to couple the vehicle 22 and the house 24 by parking the vehicle 22 at a predetermined position of the house 24. Here, the predetermined position is a position where a door 82 (a coupling part, FIG. 2) of the vehicle 22 is positioned at a target coupling position Pctar of the house 24. The automatic coupling control is started based on an operation input with respect to the automatic coupling switch 74.

### [A-1-4. House 24]

### (A-1-4-1. Overview of House 24)

As illustrated in FIG. 1, the house 24 includes a garage 100 and a parking assist device 102. The parking assist device 102 assists the vehicle 22 to park at the target parking position Ptar of the garage 100 (in the present embodiment, specifically to position the door 82 at the target coupling position Pctar).

### (A-1-4-2. Garage 100)

The garage 100 is a place where the vehicle 22 is parked. The garage 100 includes a shutter 110 and a parking space 112 as illustrated in FIG. 1 and FIG. 2. The shutter 110 opens and closes an opening 114 (FIG. 2) through which the vehicle 22 enters and exits the garage 100. The parking space 112 is a space where the vehicle 22 is parked, and is a dirt floor in the case of the first embodiment. In the first embodiment, the garage 100 is adjacent to a vehicle entrance 116. Note that the house 24 includes a normal entrance (for a person) 118 in addition to the vehicle entrance 116.

In the first embodiment, a floor 120 (FIG. 2) of the vehicle entrance 116 is configured to be couple with an inside of the vehicle 22 (for example, cargo bed). In other words, the height of the floor 120 is approximately the same as the height of the inside of the vehicle 22.

### (A-1-4-3. Parking Assist Device 102)

The parking assist device 102 assists the parking of the vehicle 22 in the garage 100. As illustrated in FIG. 1, the parking assist device 102 includes a beacon 130, a garage sensor group (garage sensors) 132, a communication device 134, a shutter actuator 136, a control unit 138, and a display device 140.

The beacon 130 notifies the vehicle 22 of the target parking position Ptar (position coordinate) of the vehicle 22. The garage sensor group 132 detects a current position Pc of the vehicle 22 in the garage 100 and includes, for example, a first image sensor that images the outside of the shutter 110, a second image sensor that images the inside of the shutter 110, and a third image sensor that is disposed near the target parking position Ptar.

The communication device 134 performs wireless communication with the vehicle 22. The shutter actuator 136 automatically opens and closes the shutter 110 and includes, for example, an electric motor.

The control unit 138 performs a coupling assist control (or parking assist control) that assists the vehicle 22 to reach the target parking position Ptar and be coupled with the house 24 (details will be described with reference to FIG. 6). The control unit 138 includes an input/output unit 150, a calculation unit 152, and a storage unit 154 as a hardware structure. The input/output unit 150 performs the input/output between the control unit 138 and another device (for example, beacon 130).

The calculation unit 152 includes a CPU and outputs parking assist information to the vehicle 22 by using programs and data stored in the storage unit 154. The parking assist information is transmitted to the vehicle 22 through the beacon 130 or the communication device 134. The storage unit 154 stores programs and data to be used by the calculation unit 152 and includes RAM. In addition to the RAM, the storage unit 154 may include ROM.

The display device 140 is disposed together with the control unit 138 and displays a status or the like of the control unit 138. The control unit 138 and the display device 140 are disposed near the parking space 122, for example (neither are shown in FIG. 2).

### [A-1-5. Management Server 26]

The management server 26 (hereinafter, also referred to as sever 26) manages the entire system 10. In the first embodiment, the management server 26 manages the rental and the return of the vehicle 22, for example.

The server 26 includes a communication unit 170, an input/output unit 172, a calculation unit 174, and a storage unit 176. The communication unit 170 performs the input/output of signals with the customer terminal 20, the vehicle 22, and the house 24. The input/output unit 172 performs input/output between an administrator of the management server 26 and the server 26. In other words, the input/output unit 172 is an HMI. The input/output unit 172 includes, for example, a keyboard, a mouse, and a display device (none of them are shown).

The calculation unit 174 includes a CPU and controls each unit of the server 26 by executing programs stored in the storage unit 176. As illustrated in FIG. 1, the calculation unit 174 includes a customer management unit 180, a reservation management unit 182, a vehicle management unit 184, and a use history management unit 186.

The customer management unit 180 manages the customer C (member) through controls regarding the customer terminal 20. The reservation management unit 182 manages the reservation and the return of the vehicle 22. The vehicle management unit 184 performs, for example, the unlocking and the locking of the vehicle 22 and the monitoring of a travel state of the vehicle 22. The use history management unit 186 (hereinafter, also referred to as history management unit 186) manages a history regarding the payment of the fee and the like. Description will be made later of a process of the calculation unit 174 with reference to FIG. 3, FIG. 4, and FIG. 7.

The storage unit 176 stores programs and data to be used by the calculation unit 174, and includes the RAM. In addition to the RAM, the storage unit 176 may include the ROM. As illustrated in FIG. 1, the storage unit 176 includes a customer database 190, a reservation database 192, a vehicle database 194, and a use history database 196.

The customer database 190 (hereinafter, referred to as customer DB 190 or DB 190) accumulates information regarding the customer C (hereinafter, also referred to as customer information Ic). The customer information Ic includes, for example, general information (name, address, telephone number, and the like) and a use history.

The reservation database 192 (hereinafter, referred to as reservation DB 192 or DB 192) accumulates information of status concerning the reservation of a vehicle (including status at the time when the rental starts, when the rental ends (the vehicle is returned)) regarding each vehicle 22 (the information is hereinafter also referred to as reservation information Ire).

The vehicle database 194 (hereinafter, referred to as vehicle DB 194 or DB 194) accumulates information regarding each vehicle 22 (hereinafter, also referred to as vehicle information Iv). The vehicle information Iv includes, for example, a vehicle model, a model year, vehicle identification number (VIN), a current position Pc, a travel distance (cumulative total, at the time when the rental starts, at the time when the rental ends, or the like), remaining vehicle driving energy, and remaining auxiliary battery.

When the vehicle 22 is a gasoline vehicle (including hybrid vehicle), the remaining vehicle driving energy indicates the remaining amount of gasoline. When the vehicle 22 is an electric vehicle (such as battery electric vehicle, hybrid vehicle, and fuel cell vehicle), the remaining energy includes the remaining amount of a high-voltage battery. When the vehicle 22 is a fuel cell vehicle, the remaining amount of energy includes the remaining amount of hydrogen gas. The remaining auxiliary battery includes the remaining amount of an auxiliary low-voltage battery (for example, a 12-V battery).

The use history database 196 (hereinafter, referred to as history DB 196 or DB 196) accumulates a history regarding the payment of the usage fee Fch and the like.

Note that, as illustrated in FIG. 1, the databases 190, 192, 194, 196 are shown separately. However, one database may include another database.

### A-2. Various Controls in First Embodiment

Next, description is made of various controls in the first embodiment.

### [A-2-1. At Reservation]

At the time of reservation of the vehicle 22, the management server 26 is accessed from the customer terminal 20. The management server 26 transmits to the customer terminal 20 information of a reservation screen (not shown). The user inputs necessary items (for example, reservation date and time, and vehicle model) on the reservation screen to reserve the vehicle 22. After the reservation information Ire is transmitted from the customer terminal 20, the management server 26 stores the reservation information Ire in the reservation DB 192.

### [A-2-2. When Using Vehicle 22]

### (A-2-2-1. When Starting Use of Vehicle 22)

FIG. 3 is a flowchart that schematically represents a use start process of the vehicle 22 (a process at the time when the use of the vehicle starts) in the first embodiment. In steps in FIG. 3, the card reader 62 and the rental management unit 66 perform step S11 that relates to the vehicle 22. The rental management unit 66 performs steps S12, S17, and S20, and the rental management unit 66 and the lock mechanism 64 perform step S16. The calculation unit 174 (reservation management unit 182) performs steps S13, S14, S15, S18, and S19 of the management server 26.

In step S11, the vehicle 22 determines whether the authentication information Iid is acquired from the card 80 of the customer C that is held over the card reader 62 provided below the rear window (not shown) or the like. If the authentication information Iid is not acquired (S11: FALSE), the vehicle 22 repeats step S11 at a predetermined cycle. If the authentication information Iid is acquired (S11: TRUE), in step S12, the vehicle 22 transmits the authentication information Iid to the management server 26.

In step S13, the management server 26 searches the reservation DB 192 for the reservation information Ire on the basis of the authentication information Iid received from the vehicle 22. Specifically, the management server 26 determines whether there is the reservation information Ire that matches a reservation time and the authentication information Iid (a person who made the reservation).

If there is the reservation information Ire (S14: TRUE), in step S15, the management server 26 transmits to the vehicle 22 a use permission notice (or unlock instruction) that permits the use of the vehicle 22. In step S16, the vehicle 22 having received the use permission notice causes the lock mechanism 64 to perform the unlocking operation.

If the vehicle 22 has been unlocked normally, in step S17, the vehicle 22 transmits an unlock notice to the management server 26. In step S18, the management server 26 having received the unlock notice inputs a use start time (a time instant when the use of the vehicle starts) to the reservation information Ire of the reservation DB 192 to update the reservation DB 192. Note that step S18 may be performed together with step S15.

Back to step S14, if there is no reservation information Ire that matches a parking space ID, the reservation time, and the authentication information Iid (the person who made the reservation) (S14: FALSE), the process advances to step S19. In step S19, the management server 26 notifies the vehicle 22 of an error (there is not the reservation information Ire). The customer terminal 20 having received the error displays the error on the display unit (input/output unit 52).

### (A-2-2-2. During and at the End of Using Vehicle 22)

### (A-2-2-2-1. Overall Sequence)

FIG. 4 is a flowchart that schematically represents a process during and at an end of using the vehicle 22 in the first embodiment. In FIG. 4, steps S21 to S25 of the vehicle 22 and steps S31 to S33 of the management server 26 are described separately. The rental management unit 66 performs steps S21 to S25 of the vehicle 22. The vehicle management unit 184 of the calculation unit 174 performs steps S31 and S32 of the management server 26, and the use history management unit 186 performs step S33.

In step S21, the vehicle 22 transmits to the management server 26, the detected values (sensor value Mc) of the travel sensor group 72. In step S22, the vehicle 22 determines whether lock conditions are satisfied. Here, the lock conditions include, for example, the following conditions (a) to (c):

(a) an engine of the vehicle 22 has been stopped;

(b) a key to the vehicle 22 has been returned to a key box of the vehicle 22; and

(c) the authentication information Iid acquired from the card 80 of the customer C that is held over the card reader 62 is the information linked with the vehicle 22 in use and the parking space to which the vehicle 22 will be returned.

If at least one of the lock conditions is not satisfied (S22: FALSE), the process returns to step S21. If the lock conditions are satisfied (S22: TRUE), in step S23, the vehicle 22 causes the lock mechanism 64 to perform the locking operation. In step S24, the vehicle 22 transmits to the management server 26, a notice (lock notice (or end-of-use notice)) that announces that the locking operation has been done.

Next, in step S25, the vehicle 22 performs an end-of-use process. The end-of-use process of the vehicle 22 will be described below with reference to FIG. 7.

In step S31, the management server 26 updates the vehicle DB 194 by using the sensor value Mc received from the vehicle 22. In step S32, the management server 26 determines whether the lock notice has been received from the vehicle 22.

If the lock notice has not been received (S32: FALSE), the process returns to step S31. If the lock notice has been received (S32: TRUE), in step S33, the management server 26 performs the end-of-use process. In the end-of-use process in the management server 26, the use history management unit 186 stores the use history in the use history DB 196.

### (A-2-2-2-2. Coupling Vehicle 22 and House 24)

### (A-2-2-2-2-1. Automatic Coupling Control in Vehicle 22)

FIG. 5 is a flowchart of an automatic coupling control in the first embodiment. As described above, the automatic coupling control is the control in which the vehicle 22 is parked at the predetermined position of the house 24 (target parking position Ptar) and is coupled to the house 24 (or the door 82 of the vehicle 22 is aligned with the target connection position Pctar of the house 24).

In step S51 in FIG. 5, the automatic coupling controller 92 of the travel controller 76 determines whether an automatic coupling start condition is satisfied. For example, the automatic coupling start condition may be the pressing of the automatic coupling switch 74. Another condition may be used as the automatic coupling start condition. For example, another condition may be that the house 24 is set as a target point (the target point may be a target parking position Ptar or a more roughly determined position) of a navigation device which is not shown, and a distance to the house 24 or the target parking position Ptar becomes equal to or less than a predetermined distance. If the automatic coupling start condition is satisfied (S51: TRUE), the process advances to step S52. If the automatic coupling start condition is not satisfied (S51: FALSE), step S51 is repeated.

In step S52, the travel controller 76 receives from the house 24 route information Ir concerning a route to the target parking position Ptar and current position information Ipc concerning the current position of the vehicle 22. The route information Ir and the current position information Ipc are received from the parking assist device 102 through the communication unit 60. Note that before starting the reception of the route information Ir and the current position information Ipc, the travel controller 76 may transmit to the control unit 138 of the house 24 a request signal for requesting the start of the transmission of the route information Ir and the current position information Ipc.

The route information Ir is information regarding a travel route around and inside the house 24. The current position information Ipc is information regarding the current position Pc of the vehicle 22 itself. The current position Pc may be acquired from the navigation device that is not shown (or global positioning system (GPS) device). However, inside the house 24, the GPS device may fail to detect the current position Pc. In view of this, the travel controller 76 may determine the current position Pc on the basis of a reception signal from the beacon 130.

In step S53, the travel controller 76 monitors the area around the vehicle 22 using information from the travel sensor group 72. Specifically, the travel controller 76 determines whether there is an obstacle such as a person or a bicycle around the vehicle 22. When monitoring the area around the vehicle 22, the travel controller 76 may acquire from the control unit 138 of the house 24 information of the garage sensor group 132 and use the information.

In step S54, the travel controller 76 adjusts a route and a speed of the vehicle 22 on the basis of the route information Ir, the current position information Ipc, and a result of monitoring the area around the vehicle 22. For example, if there is not any particular obstacle around the vehicle 22, the travel controller 76 causes the vehicle 22 to move toward the target parking position Ptar at a predetermined vehicle speed (for example, any value in the range of 1 to 10 km/h). If there is a person around the vehicle 22, the travel controller 76 causes the vehicle 22 to stop and wait until the person goes away from the vehicle 22 a predetermined distance or more.

In step S55, the travel controller 76 determines whether the vehicle 22 has reached the target parking position Ptar. If the vehicle 22 has not yet reached the target parking position Ptar (S55: FALSE), in step S56, the travel controller 76 determines whether an interruption condition is satisfied. For example, the interruption condition may be that a brake pedal (not shown) has been depressed by a predetermined amount or more. If the interruption condition is satisfied (S56: TRUE), the authority to drive the vehicle 22 is transferred to a driver and the automatic coupling control ends. If the interruption condition is not satisfied (S56: FALSE), the process returns to step S52.

In step S55, if the vehicle 22 has reached the target parking position Ptar (S55: TRUE), the travel controller 76 ends this process.

### (A-2-2-2-2-2. Coupling Assist Control in House 24)

FIG. 6 is a flowchart of the coupling assist control in the first embodiment. The coupling assist control is a control to assist the vehicle 22 to reach the target parking position Ptar and be coupled to the house 24.

In step S61 in FIG. 6, the control unit 138 of the house 24 determines whether a coupling assist start condition is satisfied. For example, the coupling assist start condition may be the reception of a request signal from the travel controller 76. If the coupling assist start condition is satisfied (S61: TRUE), the process advances to step S62. If the coupling assist start condition is not satisfied (S61: FALSE), step S61 is repeated (or monitoring continues).

In step S62, the control unit 138 activates the shutter actuator 136 to open the shutter 110. In step S63, the control unit 138 detects the current position Pc of the vehicle 22 on the basis of detected values sent from the garage sensor group 132.

In step S64, the control unit 138 transmits to the vehicle 22 the current position information Ipc of the vehicle 22 and the route information Ir concerning a route from the current position Pc of the vehicle 22 to the target parking position Ptar (target coupling position Pctar). If the shutter 110 has not completely been opened, a route indicated by the route information Ir may end in front of the shutter 110. The parking assist device 102 transmits the route information Ir and the current position information Ipc to the travel controller 76 through the communication device 104.

In step S65, the control unit 138 determines whether the vehicle 22 has reached the target parking position Ptar. If the vehicle 22 has not yet reached the target parking position Ptar (S65: FALSE), in step S66, the control unit 138 determines whether an interruption condition is satisfied. For example, the interruption condition may be the reception of an interruption signal from the travel controller 76. If the interruption condition is satisfied (S66: TRUE), the control unit 138 ends this coupling assist control. If the interruption condition is not satisfied (S66: FALSE), the process returns to step S63.

If the vehicle 22 has reached the target parking position Ptar in step S65 (S65: TRUE), the control unit 138 activates the shutter actuator 136 and closes the shutter 110 in step S67. The timing of closing the shutter 110 may be triggered by the separation of the vehicle 22 away from the shutter 110 by a predetermined distance. Alternatively, the shutter 110 may be closed by activating the shutter actuator 136 on the basis of an instruction of the user. Furthermore, the shutter 110 can be closed manually.

### (A-2-2-2-3. End-of-Use Process)

FIG. 7 is a flowchart that schematically represents the end-of-use process of the vehicle 22 in the first embodiment (details of S25 in FIG. 4). The charge management unit 90 of the vehicle 22 performs steps S81 to S85 of FIG. 7.

In step S81, the charge management unit 90 finalizes fee calculation information Ifc for calculating the usage fee Fch for the use of the vehicle 22. The fee calculation information Ifc includes, for example, the travel distance (moving distance D), a usage time, and the vehicle model of the vehicle 22. The usage time corresponds to a time period from the start of use to the end of use. The start of use is, for example, the time instant when the vehicle 22 is unlocked (S16 in FIG. 3). The end of use is, for example, the time instant when the vehicle 22 is locked (S23 or S33 in FIG. 4).

In step S82, the charge management unit 90 calculates the usage fee Fch (billing information Ich) on the basis of the fee calculation information Ifc that has been finalized. In step S83, the charge management unit 90 notifies the user of the usage fee Fch through the automatic adjustment machine 68. Specifically, the automatic adjustment machine 68 includes a display device and a speaker, which are not shown, and causes the display device to display the usage fee Fch and outputs audible information from the speaker.

When the usage fee Fch is paid to the automatic adjustment machine 68 (S84: TRUE), in step S85, the charge management unit 90 transmits to the management server 26, the usage fee Fch, a use start (start-of-use) date and time, a return date and time, and the like regarding the current use. The use history management unit 186 of the management server 26, receiving these pieces of data, stores the data in the history DB 196.

### A-3. Effect of First Embodiment

As described above, in the first embodiment, the vehicle 22 (mobility room) autonomously moves based on a movement request (second movement request), which is a request for moving, from the user in the vehicle compartment 78 (room main body) to cause the door 82 (coupling part) of the vehicle 22 to reach the target coupling position Pctar of the house 24 (building) (see FIG. 2, FIG. 5, and FIG. 6). This enables the door 82 of the vehicle 22 to reach the target coupling position Pctar of the house 24 easily.

In the first embodiment, the vehicle 22 (mobility room) includes the charge management unit 90 (fee calculation device) that calculates the usage fee Fch for the vehicle 22 on the basis of the distance D the vehicle 22 has moved over, and charges the user the usage fee Fch (see FIG. 1 and FIG. 7). This enables to calculate and charge the fee Fch of the vehicle 22 easily.

### B. Second Embodiment

### B-1. Structure (Difference from First Embodiment)

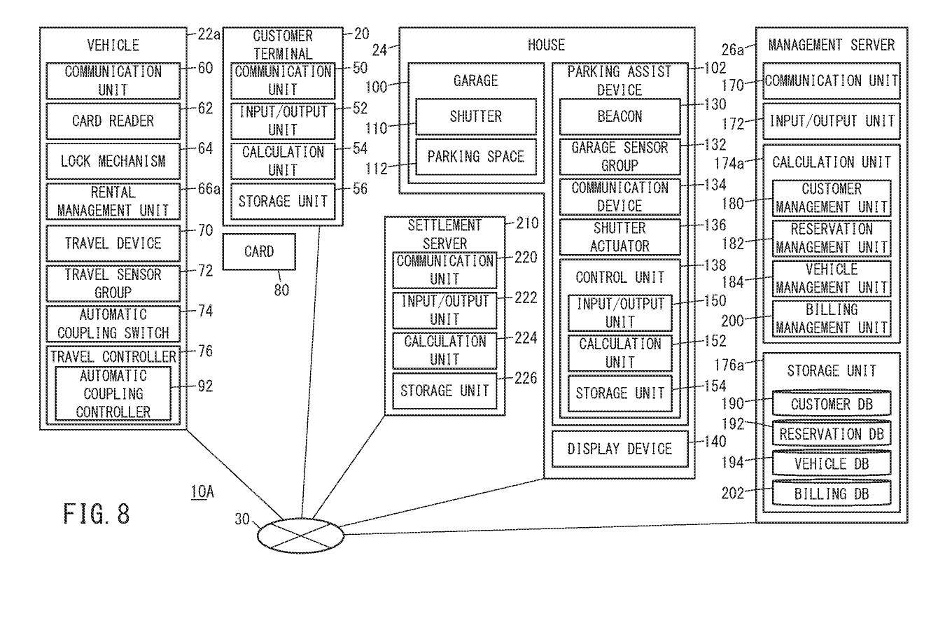

FIG. 8 is a schematic structure diagram of a vehicle management system 10A (hereinafter, also referred to as management system 10A or system 10A) as a mobility room management system according to a second embodiment of the present invention. Among components in the management system 10A according to the second embodiment, the components similar to those of the management system 10 according to the first embodiment are given the same reference numerals, and detailed description thereof is omitted.

In the first embodiment, the user performs a settlement in the vehicle 22 (FIG. 7). In the second embodiment, the settlement is performed by using credibility information. Specifically, the vehicle 22 according to the first embodiment includes the charge management unit 90 and the automatic adjustment machine 68 (FIG. 1). In other words, the payment method is similar to that of a taxi. Meanwhile, a vehicle 22a according to the second embodiment does not include the charge management unit 90 or the automatic adjustment machine 68. Alternatively, a rental management unit 66a of the vehicle 22a transmits to a management server 26a the information (fee calculation information Ifc) for calculating the usage fee Fch. As above, examples of the fee calculation information Ifc are the travel distance (movement distance D), the use time, and the vehicle model of the vehicle 22a.

The management server 26a calculates the usage fee Fch on the basis of the fee calculation information Ifc from the vehicle 22a. Therefore, a calculation unit 174a of the management server 26a includes a billing management unit 200 instead of the use history management unit 186. In addition, a storage unit 176a of the management server 26a includes a billing database 202 (hereinafter, referred to as billing DB 202). The billing management unit 200 stores the usage fee Fch calculated based on the fee calculation information Ifc in the billing DB 202 and transmits the usage fee Fch to a settlement server 210.

The settlement server 210 performs a settlement of the rental of the vehicle 22a. The settlement server 210 includes a communication unit 220, an input/output unit 222, a calculation unit 224, and a storage unit 226.

The communication unit 220 performs the input/output of signals with the customer terminal 20 and the management server 26a. The input/output unit 222 performs the input/output between an administrator of the settlement server 210 and the settlement server 210. The input/output unit 222 includes, for example, a keyboard, a mouse, and a display device (none of them are shown). In other words, the input/output unit 222 is an HMI.

The calculation unit 224 includes a CPU and controls each unit of the settlement server 210 by executing programs stored in the storage unit 226. For example, in response to an inquiry regarding the credibility of the customer C from the management server 26a, the calculation unit 224 outputs information regarding credit (hereinafter, credit information Icr). Further, after acquiring from the management server 26a the billing information Ich about the use of the vehicle 22a, the calculation unit 224 bills the customer C for the usage fee and the like on the basis of the billing information Ich (including making withdrawals from a bank account). In addition, the calculation unit 224 performs payment to a management company of the management server 26a (such as transferring money to a bank account). That is to say, the settlement server 210 collects the usage fee from the customer C on behalf of beneficial owners.

The storage unit 226 stores programs and data to be used by the calculation unit 224 and includes the RAM. In addition to the RAM, the storage unit 226 may include the ROM. The storage unit 226 includes a credit database and a settlement database that are not shown.

The credit database accumulates credit information Icr about each customer C. The settlement database accumulates settlement information Is for each customer C and each management company of the management server 26a. The settlement information Is includes payment information (payables information) which is information regarding the payment from a management company of the settlement server 210 to the management company of the management server 26a, and the billing information Ich (receivables information) regarding the customer C.

### B-2. Various Controls in Second Embodiment

### [B-2-1. Overview]

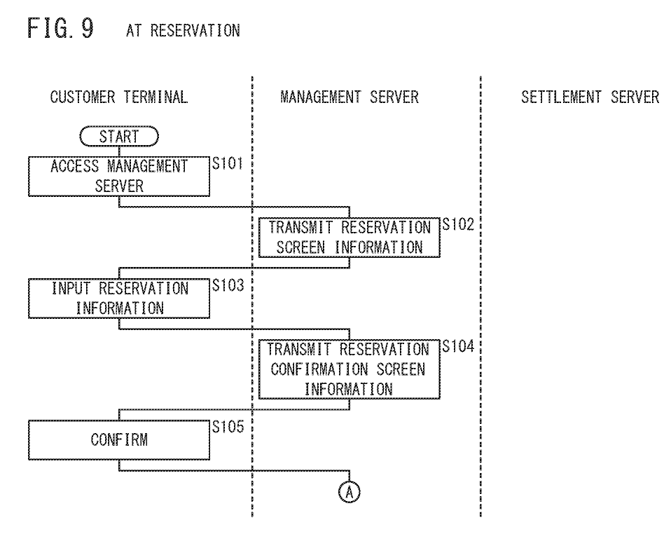

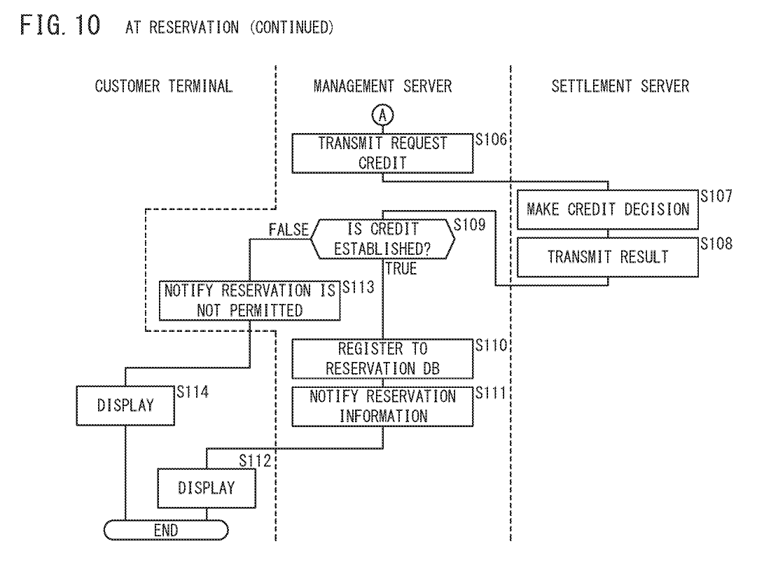

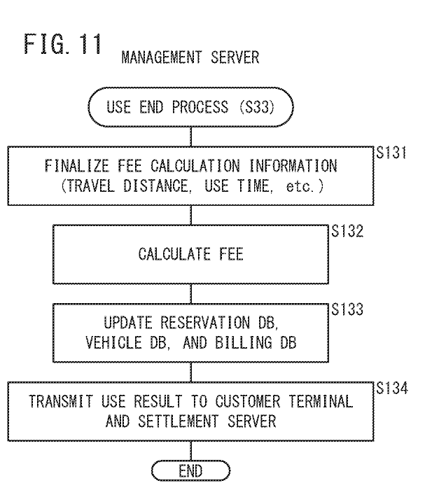

Controls in the second embodiment are basically similar to those in the first embodiment. For example, FIG. 3 to FIG. 6 can also be applied to the second embodiment. However, the second embodiment is different from the first embodiment in the control regarding the settlement. In other words, in the second embodiment as described below, a reservation process in FIG. 9 and FIG. 10, and an end of use process in FIG. 11 are performed.

### [B-2-2. Reservation Process]

FIG. 9 and FIG. 10 are first and second flowcharts that schematically represent the reservation process in the second embodiment. Among steps in FIG. 9 and FIG. 10, the calculation unit 54 performs steps S101, S103, S105, S112, and S114 which belong to the customer terminal 20. The reservation management unit 182 of the calculation unit 174a performs steps S102, S104, S110, S111, and S113 which belong to the management server 26a, and the billing management unit 200 of the calculation unit 174a performs steps S106 and S109. The calculation unit 224 performs steps S107 and S108 of the settlement server 210.

In step S101, the user of the customer terminal 20 (that is, customer C) accesses the management server 26a through the customer terminal 20. In other words, the customer terminal 20 accesses a website of the management server 26a in accordance with the operation and input of the user. In step S102, the management server 26a transmits the information (reservation screen information) regarding the screen for the reservation (reservation screen) in accordance with the operation and input from the customer terminal 20.

In step S103, the user inputs the reservation information Ire into the reservation screen and transmits the reservation information Ire to the management server 26a. In other words, the customer terminal 20 displays the reservation screen on the display device (input/output unit 52) on the basis of the reservation screen information from the management server 26a. Then, the customer terminal 20 displays the reservation information Ire on the display device in accordance with the input of the user. If the user selects a transmission button in the display device, the customer terminal 20 transmits to the management server 26a the reservation information Ire that has been input.

When the vehicle 22a is reserved, the management server 26a first transmits login screen information to the customer terminal 20 and requests the input of a login ID and a password. Only when an authentication of the customer C (member) is successful with the login ID and the password, the reservation of the vehicle 22a is permitted.

In step S104, the management server 26a transmits to the customer terminal 20 information (reservation confirmation screen information) of a confirmation screen (reservation confirmation screen) for confirming the reservation information Ire received from the customer terminal 20.

In step S105, the user confirms the content of the reservation confirmation screen and presses a registration button (not shown) in the reservation confirmation screen. In other words, the customer terminal 20 displays the reservation confirmation screen on the display device (input/output unit 52) on the basis of the reservation confirmation screen information sent from the management server 26a. Then, after the registration button is selected, the customer terminal 20 transmits to the management server 26a a notice (reservation information confirmation notice) that announces that the input reservation information Ire has been confirmed.

In step S106 in FIG. 10, the management server 26a transmits to the settlement server 210 a credit request in addition to the customer information Ic. Here, the customer information Ic includes, for example, a credit card number and a name of the customer C. In step S107, the settlement server 210 having received the credit request decides whether to let the customer C have credit, on the basis of the customer information Ic from the management server 26a and the credit information Icr (corresponding to customer information Ic) in the credit database. In the following step S108, the settlement server 210 transmits a result of the credit decision to the management server 26a.

In step S109, the management server 26a determines whether the result of the credit decision received from the settlement server 210 indicates that the credit is offered (the customer C qualifies as having credit). If the credit is established (S109: TRUE), in step S110, the management server 26a registers the reservation information Ire to the reservation DB 192. This finalizes the reservation of the vehicle 22a. The reservation information Ire can be temporarily registered to the reservation DB 192 in step S106 and formally registered in step S110. In this case, if the credit is not established (S109: FALSE), the management server 26a erases temporary registration information.

In step S111, the management server 26a notifies the customer terminal 20 of the finalized reservation information Ire (and the fact that the reservation is finalized). In step S112, the customer terminal 20 having received the notice displays the reservation information Ire.

Back to step S109, if the result of the credit decision received from the settlement server 210 indicates that the credit is refused (credit is not established) (S109: FALSE), in step 113, the management server 26a notifies the customer terminal 20 that the reservation is impossible. In step S114, the customer terminal 20 having received the notice displays the content of the notice.

### [B-2-3. End-of-Use Process]

FIG. 11 is a flowchart that schematically represents the end-of-use process in the management server 26a according to the second embodiment. As described above, the controls in the second embodiment are basically similar to those in the first embodiment. For example, FIG. 3 to FIG. 6 can also be applied to the second embodiment. The flowchart in FIG. 11 is the details of step S33 in FIG. 4.

Among steps in FIG. 11, the billing management unit 200 of the calculation unit 174a performs steps S131 and S132 and the reservation management unit 182, the vehicle management unit 184, and the billing management unit 200 of the calculation unit 174a perform step S133. The customer management unit 180 and the billing management unit 200 perform step S134.

In step S131, the management server 26a finalizes the fee calculation information Ifc for calculating the usage fee Fch for using the vehicle 22a. The fee calculation information Ifc includes, for example, the travel distance (movement distance D), the use time, and the vehicle model of the vehicle 22a. As described above, the travel distance of the vehicle 22a is transmitted from the vehicle 22a to the management server 26a (S21 in FIG. 4).

The use time corresponds to a time period from the start of use to the end of use. For example, the start of use can be a time instant when the management server 26a receives the unlock notice from the vehicle 22a (S18 in FIG. 3) or transmits the use permission notice to the vehicle 22a (S15). For example, the end of use can be a time instant when the management server 26a receives the lock notice from the vehicle 22a (S32 in FIG. 4: TRUE).

In step S132, the management server 26a calculates the usage fee Fch (billing information Ich) on the basis of the finalized fee calculation information Ifc and fee information If in the billing DB 202.

In step S133, the management server 26a updates the reservation DB 192, the vehicle DB 194, and the billing DB 202 in order to reflect the current use. Specifically, with respect to the reservation DB 192, the management server 26a (reservation management unit 182) registers the return date and time. With respect to the vehicle DB 194, the management server 26a (vehicle management unit 184) registers a state (for example, travel distance, remaining vehicle driving energy) of the vehicle 22a when the vehicle 22a is returned. With respect to the billing DB 202, the management server 26a (billing management unit 200) registers a bill F (the amount to be billed), the use start date and time, the return date and time, and the like concerning the usage of the vehicle 22a.

In step S134, the management server 26a transmits a result incurred by the usage of the vehicle 22a to the settlement server 210 and the customer terminal 20 of the customer C who has used the vehicle 22a.

The management server 26a (billing management unit 200a) transmits to the customer terminal 20 a message of gratitude for using the vehicle 22a, the use date and time and the travel distance of the vehicle 22a, and the bill F calculated as a result of using the vehicle 22a. The customer terminal 20 (calculation unit 54) having received these pieces of information displays the information on the display device (input/output unit 52).

Further, the management server 26a (billing management unit 200) transmits to the settlement server 210 the bill F and the use date. The settlement server 210 (calculation unit 224) having received these pieces of information performs a billing process for the customer C. The billing process is a process for adding up the bills F to yield a monthly total for each customer C.

### B-3. Effect of Second Embodiment

In the second embodiment as described above, the following effects are obtained in addition to or instead of the effects in the first embodiment.

In the second embodiment, in a manner similar to that in the first embodiment, the vehicle 22a (mobility room) autonomously moves based on a request from the customer terminal 20 (external terminal) to cause the door 82 (coupling part) of the vehicle 22a to reach the target coupling position Pctar of the house 24 (building) (FIG. 5 and FIG. 6). This enables the door 82 of the vehicle 22a to reach the target coupling position Pctar of the house 24 easily.

Further, since the management server 26a controls a plurality of vehicles 22a, the vehicles 22a can be controlled efficiently.

In the second embodiment, the mobility room management system 10A includes, for each user, the billing DB 202 (payment status database) that manages a payment status of the usage fee Fch (FIG. 8). When accepting a reservation (movement request) from the customer terminal 20 (external terminal), the management server 26a acquires the user identification information (S102 in FIG. 9) and checks the payment status of the usage fee Fch in accordance with the user identification information (S109 in FIG. 10). If there is a delay in paying the usage fee Fch, the reservation is not accepted (S113). This enables to urge the user to pay the usage fee Fch.

### C. Third Embodiment

### C-1. Structure (Difference from First and Second Embodiments)

### [C-1-1. Overview]

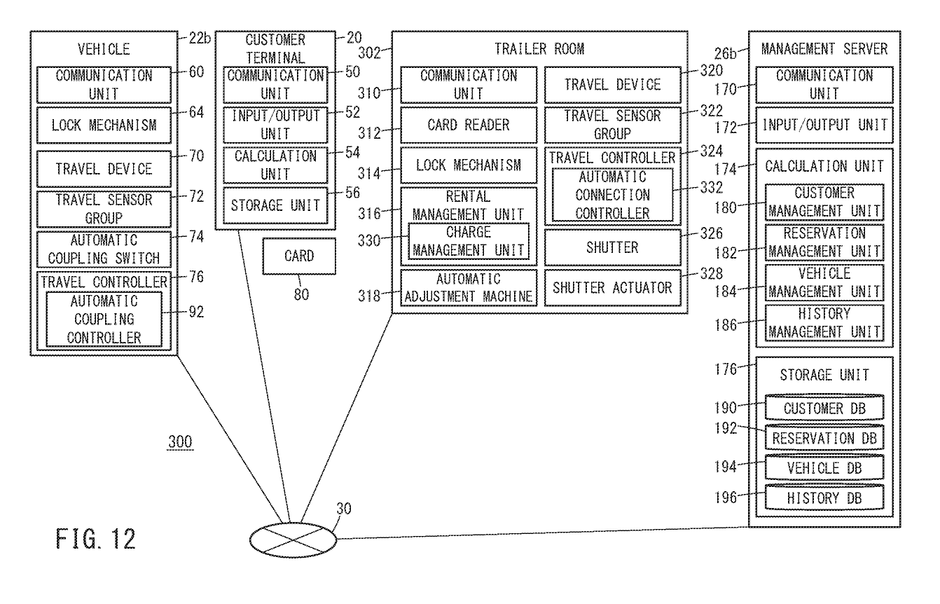

FIG. 12 is a schematic structure diagram of a trailer room management system 300 (hereinafter, also referred to as management system 300 or system 300) as a building management system (or mobility room management system) according to a third embodiment of the present invention. Among components in the management system 300 according to the third embodiment, the component that is similar to that in the management system 10 according to the first embodiment or the management system 10A according to the second embodiment is denoted by the same reference symbol, and detailed description is omitted.

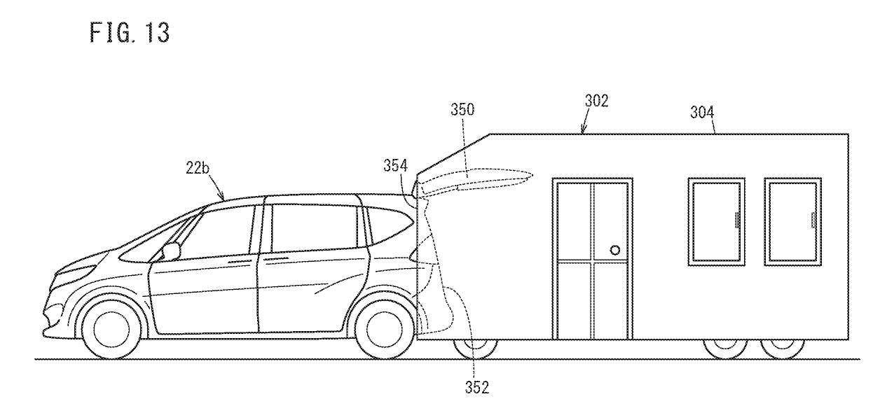

In the first embodiment, the vehicle 22 and the house 24 are coupled (FIG. 2) and in the second embodiment as well. Meanwhile, in the third embodiment, a vehicle 22b (first vehicle) and a self-traveling trailer room 302 (second vehicle) are coupled (FIG. 13).

In the first embodiment, the user pays the usage fee Fch for the vehicle 22 which is considered to be a rental car (FIG. 1). Meanwhile, in the third embodiment, the user owns the vehicle 22b but pays a usage fee Fch for the self-traveling trailer room 302 (hereinafter, also referred to as trailer room 302) which is considered to be a rental car. Therefore, the vehicle 22b does not include the card reader 62, the rental management unit 66, or the automatic adjustment machine 68, but includes the automatic coupling switch 74 and the automatic coupling controller 92 instead; thus, the vehicle 22b can perform the automatic coupling control. Further, the trailer room 302 includes a structure for charging the usage fee Fch.

### [C-1-2. Trailer Room 302]

FIG. 13 is a side view expressing a coupling state between the vehicle 22b and the trailer room 302 included in the trailer room management system 300 as a mobility room management system according to the third embodiment. The trailer room 302 can travel without an operation of the driver (that is, capable of autonomous traveling). In addition, in a state that a housing 304 (room main body) of the trailer room 302 is fixed, the user can live in the housing 304. Therefore, the trailer room 302 corresponds to both the mobility room and the building.

As illustrated in FIG. 12, the trailer room 302 includes a communication unit 310, a card reader 312, a lock mechanism 314, a rental management unit 316, an automatic adjustment machine 318, a travel device 320, a travel sensor group 322, a travel controller 324, a shutter 326, and a shutter actuator 328.

The communication unit 310, the card reader 312, the lock mechanism 314, and the automatic adjustment machine 318 can be the communication unit 60, the card reader 62, the lock mechanism 64, and the automatic adjustment machine 68 of the first embodiment, respectively. The travel device 320, the travel sensor group 322, and the travel controller 324 are the travel device 70, the travel sensor group 72, and the travel controller 76 of the first embodiment, respectively but are used for the autonomous traveling as described above. Thus, the travel device 320, the travel sensor group 322, and the travel controller 324 do not include a structure for the driver to drive. An automatic coupling controller 332 of the travel controller 324 performs the automatic coupling control to assist the vehicle 22b to be coupled to the trailer room 302.

The rental management unit 316 is similar to the rental management unit 66 in the first embodiment regarding a basic rental management function. A charge management unit 330 of the rental management unit 316 charges the fee in accordance with the usage of the trailer room 302. However, while the rental management unit 66 in the first embodiment manages the rental of the vehicle 22 that is connected to the house 24, the rental management unit 316 in the third embodiment manages the rental of the trailer room 302.

The rental management unit 316 controls the opening and closing of the shutter 326 through the shutter actuator 328. The shutter 326 is provided on a front surface of the trailer room 302. In a state that the shutter 326 is closed, the vehicle 22b cannot be coupled to the trailer room 302. In other words, a person cannot come and go between the inside of the vehicle 22b and the inside of the trailer room 302. In a state that the shutter 326 is opened, the vehicle 22b can be coupled to the trailer room 302.

In other words, in a state that the shutter 326 and a tail gate 350 of the vehicle 22b (FIG. 13) are opened, a rear opening 352 of the vehicle 22b side and a front opening 354 of the trailer room 302 side (coupling parts) are disposed so as to face each other. Thus, a person can come and go between the inside of the vehicle 22b and the inside of the trailer room 302. Therefore, the shutter 326 works as a coupling regulation device that regulates the coupling between the rear opening 352 and the front opening 354.

Note that a sensor may be provided in the trailer room 302 in order to detect that the tail gate 350 is opened in the trailer room 302. Examples of such a sensor include an image sensor and a touch sensor.

If the trailer room 302 is prohibited from traveling on a public road, the trailer room 302 may travel only on a private ground such as a campsite.

### [C-1-3. Charge Management Unit 330]

The charge management unit 330 in the third embodiment counts, through the communication unit 310, a coupling time T [min] of the coupling between the vehicle 22b and the trailer room 302. The charge management unit 330 calculates the usage fee Fch on the basis of the coupling time T.

### C-2. Various Controls in Third Embodiment

### [C-2-1. At Reservation]

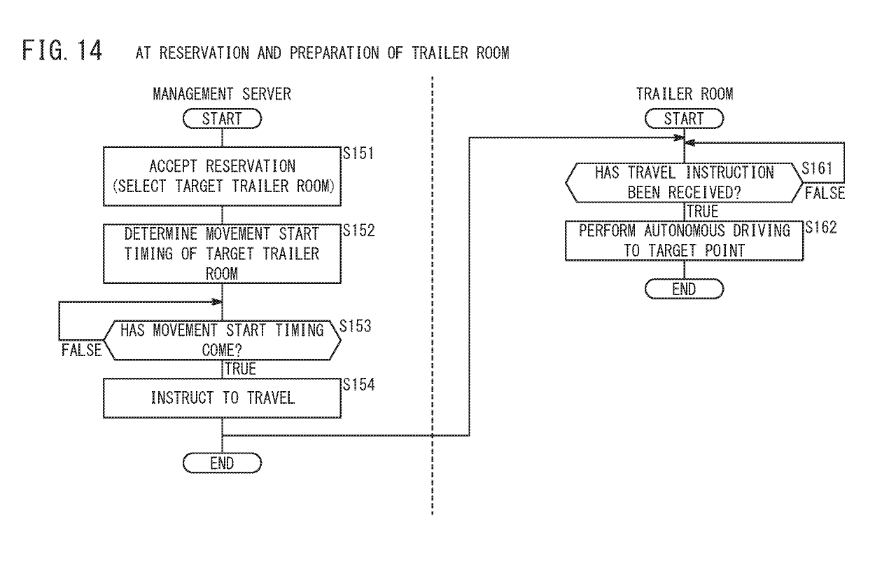

FIG. 14 is a flowchart that schematically represents a process at a reservation of the trailer room 302 and preparations for using the trailer room 302 in the third embodiment. Among steps in FIG. 14, the reservation management unit 182 performs steps S151 to S153 on a management server 26b side, and the vehicle management unit 184 performs step S154. The travel controller 324 performs steps S161 and S162 on the trailer room 302 side.

In step S151, the management server 26b accepts the reservation from the customer terminal 20. An overall sequence at the reservation of the trailer room 302 of the present embodiment is similar to those of the first and second embodiments. In the third embodiment, however, the user specifies, through the customer terminal 20, a use time (connection time T) (a time period during which the user uses the trailer room 302), a use start time (a time instant when the user starts using the trailer room 302), a use start place (a place where the user starts using the trailer room 302), and a use end place (a place where the user stops using the trailer room 302). The reservation management unit 182 of the management server 26b having accepted the reservation of the trailer room 302 selects a trailer room 302 (target trailer room 302tar) that matches requests in the reservation, by using data in the vehicle DB 194 (room database), and stores information about the selected trailer room 302 in the reservation DB 192.

### [C-2-2. When the Use of Trailer Room 302 is Prepared]

After accepting the reservation of the trailer room 302, the management server 26b determines the timing (movement start timing) of a start of movement of the target trailer room 302tar in step S152. The movement start timing is when the target trailer room 302tar starts to move so that the target trailer room 302tar reaches the use start place by the use start time. The management server 26b determines the movement start timing on the basis of a current position Pc, the use start time, and the use start place of the trailer room 302. In this determination, the management server 26b may acquire and use traffic information such as congestion information and construction information from a traffic information server (not shown) through the communication unit 170.

If the movement start timing of the target trailer room 302tar has not yet come (S153: FALSE), step S153 is repeated. If the movement start timing of the target trailer room 302tar has come (S153: TRUE), the management server 26b instructs the trailer room 302 to travel in step S154. In this travel instruction (instruction to travel), the management server 26b notifies the target trailer room 302tar of the target point. In addition, the travel instruction includes information about a target travel route to the target point.

Each trailer room 302 monitors whether the travel instruction has been received every predetermined cycle (S161). The trailer room 302 having received the travel instruction (target trailer room 302tar) performs the autonomous driving toward the target point which is the use start place (S162).

### [C-2-3. When Trailer Room 302 is Used]

At the use start position, if the vehicle 22b comes close to the trailer room 302, the vehicle 22b (automatic coupling controller 92) performs the automatic coupling control that is similar to that of the first embodiment (FIG. 5). Further, the trailer room 302 (automatic coupling controller 332) performs the assist control that is similar to that of the first embodiment (FIG. 6). In this way, the vehicle 22b is coupled to the trailer room 302.

At the end of the coupling between the vehicle 22b and the trailer room 302, the charge management unit 330 calculates the usage fee Fch on the basis of the connection time T and displays the usage fee Fch on the automatic adjustment machine 318 (on a display device that is not shown). In addition, the charge management unit 330 accepts the payment from the user through the automatic adjustment machine 318. After the payment from the user is completed and the use of the trailer room 302 ends, the trailer room 302 moves to a next waiting place on the basis of an instruction of the management server 26b.

Note that, in FIG. 14, after one trailer room 302 (target trailer room 302tar) is reserved, the target trailer room 302tar autonomously travels to the target point. Actually, the management server 26b performs the process in the flowchart in FIG. 14 for a plurality of trailer rooms 302 (target trailer rooms 302tar). Therefore, note that after accepting the reservation in step S151, the management server 26b performs another reservation, for example. In regard to the determination of the movement start timing of the target trailer room 302tar (S152, S153), the movement start timings of the plurality of target trailer rooms 302tar are determined at the same time.

### C-3. Effect of Third Embodiment

In the third embodiment as described above, the following effects are obtained in addition to or instead of the effects in the first and second embodiments.

In the third embodiment, the mobility room management system 300 (building management system) includes: the front opening 354 (moving object side coupling part) configured to be coupled to the inside of the vehicle 22b (mobility room) through the rear opening 352 (room side coupling part) of the vehicle 22b and to enable the user to move; and the charge management unit 330 (charge device) configured to calculate the usage fee Fch in accordance with the connection time T between the rear opening 352 and the front opening 354 and to charge the usage fee Fch (FIG. 12).

According to the third embodiment, the usage fee Fch matching the connection time T between the rear opening 352 of the vehicle 22b and the front opening 354 of the trailer room 302 can be charged.

In the third embodiment, the management server 26b includes: the communication unit 170 (server communication unit) configured to be able to communicate with the outside; the calculation unit 174 (room controller) configured to control the plurality of trailer rooms 302 (mobility rooms); and the vehicle DB 194 (room database) configured to store the data of the plurality of trailer rooms 302 (FIG. 12). The calculation unit 174 of the server 26b is configured to receive the reservations (use requests) of the trailer rooms 302 from the plurality of customer terminals 20 (external terminals) through the communication unit 170 (S151 in FIG. 14). The calculation unit 174 is configured to select the trailer room 302 that satisfies the reservation by using the vehicle DB 194 (S151). In addition, the calculation unit 174 is configured to transmit the travel instruction (use instruction) that satisfies demands in the reservation to the target trailer room 302tar corresponding to the trailer room 302 that is selected through the communication unit 170 (S154).

In the third embodiment, the travel instructions that correspond to the reservations are transmitted to the target trailer rooms 302tar that correspond to the demands in the reservations of the trailer rooms 302 received from the plurality of customer terminals 20. This enables to use the plurality of trailer rooms 302 suitably.

### D. Modifications

The present invention is not limited to the above embodiments and can employ various structures on the basis of the description of the present specification. For example, the following structures can be employed.

### D-1. House 24

In the first embodiment, the building to which the vehicle 22 is coupled is the house 24 (FIG. 1 and so on). However, for example, the present invention is not limited to this example from the viewpoint that a mobility room such as the vehicle 22 is automatically coupled to the building such as the house 24 or other moving objects. For example, the vehicle 22 may be coupled to other types of building. This also applies to the second and third embodiments.

In the first embodiment, the parking space 112 is provided inside the house 24 (FIG. 2). However, for example, the present invention is not limited to this example from the viewpoint that a mobility room such as the vehicle 22 is automatically coupled to the building such as the house 24 or other moving objects. For example, the parking space 112 may be provided outside the house 24. This also applies to the second embodiment.

### D-2. Vehicle 22

The vehicle 22 in the first embodiment is the battery electric vehicle (FIG. 1). However, for example, the present invention is not limited to this example from the viewpoint that the vehicle 22 is automatically coupled to the building such as the house 24 or other moving objects. For example, the vehicle 22 may be a hybrid vehicle including an engine and a driving motor as a power source. This also applies to the second and third embodiments.

In the first embodiment, a moving object to be coupled to the house 24 or the building is the vehicle 22 (FIG. 1, for example). However, for example, the present invention is not limited to this example from the viewpoint that a mobility room is automatically coupled to the building such as the house 24 or other moving objects. For example, when the house 24 or the building faces water such as a lake, the moving object to be coupled to the house 24 or the building may be a ship. This also applies to the second and third embodiments. Alternatively, the present invention may be applied to moving objects other than a vehicle.

In the first embodiment, the automatic coupling controller 92 performs the automatic coupling control by using the information acquired from the parking assist device 102 of the house 24 (FIG. 5). However, for example, the present invention is not limited to this example from the viewpoint that a mobility room such as the vehicle 22 is automatically coupled to the building such as the house 24 or other moving objects. For example, the automatic coupling control can be performed by using only information acquired by the vehicle 22 itself. This also applies to the second and third embodiments.

In the first embodiment, the vehicle 22 to be coupled to the house 24 is the rental car (FIG. 1). However, for example, the present invention is not limited to this example from the viewpoint that a mobility room such as the vehicle 22 is automatically coupled to the building such as the house 24 or other moving objects. For example, the vehicle 22 can be a vehicle owned by the user. Alternatively, if the vehicle 22 can autonomously travel without the driving operation of the driver, the vehicle 22 can be a taxi.

### D-3. Controls

In the second embodiment, if the credit is refused (S109 in FIG. 10: FALSE), the reservation is not accepted (S113). However, for example, the present invention is not limited to this example from the viewpoint that, if the credit is refused (for example, because payment is overdue), the use of the vehicle 22a is restricted. For example, if the payment is overdue, the management server 26a can accept the reservation but restrict the use of the vehicle 22a (for example, restrict the riding of the vehicle). The restriction of using the vehicle 22a on the basis of the credit information Icr can be performed on the vehicle 22a side. This also applies to the trailer room 302.

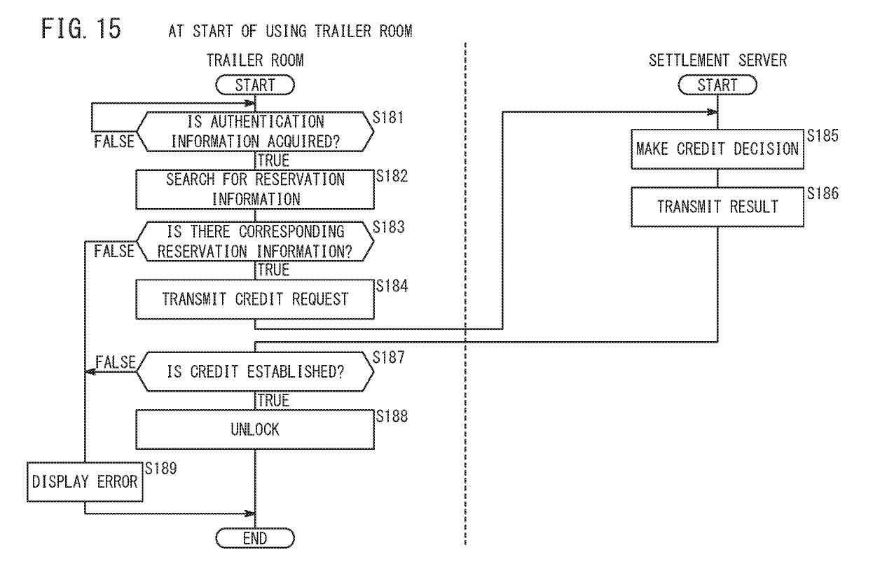

FIG. 15 is a flowchart that schematically represents a use start process of the trailer room 302 in a modification. The structure of the modification in FIG. 15 is basically similar to that of the third embodiment (FIG. 12), and includes the settlement server 210 (FIG. 8) that is similar to that in the second embodiment. In the modification in FIG. 15, the trailer room 302 receives the reservation information Ire from the management server 26b in advance and stores the reservation information Ire in an unshown storage unit of the rental management unit 316. The rental management unit 316 (use possible/impossible determination unit) transmits the credit request to the settlement server 210 and determines whether the trailer room 302 can be used.

In step S181 in FIG. 15, the trailer room 302 determines whether the authentication information Iid (user identification information) is acquired from the card 80 of the customer C that is held over the card reader 312 (identification information acquisition unit). If the authentication information Iid is acquired from the card 80 of the customer C (S181: TRUE), in step S182, the rental management unit 316 of the trailer room 302 searches the storage unit of the rental management unit 316 for the reservation information Ire on the basis of the acquired authentication information Iid. Specifically, the rental management unit 316 determines whether there is the reservation information Ire that corresponds to the reservation time and the authentication information Iid (person who made the reservation).

If there is such reservation information Ire (S183: TRUE), in step S184, the rental management unit 316 transmits the credit request to the settlement server 210 through the communication unit 310 (room communication unit) in addition to the authentication information Iid. In step S185, the settlement server 210 having received the credit request makes the credit decision on the basis of the authentication information Iid from the trailer room 302 and the credit information Icr (for authentication information Iid) in the credit database. In the following step S186, the settlement server 210 transmits a result of the credit decision to the trailer room 302.

In step S187, the rental management unit 316 of the trailer room 302 determines whether the result of the credit decision received from the settlement server 210 through the communication unit 310 indicates that the credit is permitted (whether the credit is established). If the credit is established (S187: TRUE), in step S188, the rental management unit 316 causes the lock mechanism 314 to perform the unlocking operation. After step S188, the processes that are similar to steps S17 and S18 in FIG. 3 may be performed.

If there is not the reservation information (S183: FALSE) or the credit is not established (S187: FALSE), the rental management unit 316 displays an error on a display unit that is not shown.

In the modification as above, it is possible to urge the user to pay the usage fee Fch.

In the third embodiment, if the use start timing of the target trailer room 302tar has come (S153 in FIG. 14: TRUE), the management server 26b transmits the travel instruction to the target trailer room 302tar (S154). However, for example, the present invention is not limited to this example from the viewpoint that the management server 26b transmits to the target trailer room 302tar the instruction regarding the use in accordance with the reservation (or use request from user) through the customer terminal 20.

For example, when receiving the reservation (S151 in FIG. 14), the management server 26b may transmit the use instruction to the target trailer room 302tar. Here, the use instruction includes information on the use start time and the use start place. Further, the use instruction may include the use time (connection time T) and the use end place.

In the third embodiment, the travel instruction (S154 in FIG. 14) from the management server 26b to the target trailer room 302tar includes information on the target point. In other words, the management server 26b notifies the target trailer room 302tar of the target point. However, for example, the present invention is not limited to this example from the viewpoint of the use of the trailer room 302. For example, the trailer room 302 can be disposed at a particular place (parking space, for example), and the user can go to the particular place and use the trailer room 302.

What is claimed is:

1. A mobility room comprising:
a room main body configured to form a living space;
a movement device configured to move the room main body freely;
a coupling part configured to couple an inside of the room main body and an inside of a building or another moving object to enable a user to move; and
a movement control unit configured to move the room main body autonomously using the movement device to cause the coupling part to reach a target coupling position with respect to the building or the another moving object on the basis of a first movement request input to an operation input device provided to the room main body or a second movement request received from an external device through a communication device.

2. The mobility room according to claim 1, further comprising a fee calculation device configured to calculate a fee for using the mobility room for the user on the basis of a movement distance of the mobility room or a connection time between the mobility room and the building or the other moving object, and to charge the user the fee or to display the fee on a display device or transmit the fee to the external device through the communication device.

3. The mobility room according to claim 2, further comprising:
an identification information acquisition unit configured to acquire user identification information that is information for identifying the user;
a room communication unit configured to be able to communicate with the external device;
a use possible/impossible determination unit configured to determine whether to allow use of the mobility room wherein
the use possible/impossible determination unit is configured to
transmit to the external device through the room communication unit the user identification information acquired by the identification information acquisition unit and a payment status information request that requests payment status information regarding a payment status of the user,
acquire the payment status information of the user indicated by the user identification information from the external device through the room communication unit, and
forbid the user to use the mobility room if the payment status information indicates that payment of the fee is overdue.

4. A mobility room management system comprising:
a plurality of mobility rooms configured to be able to move autonomously; and
a management server configured to control the plurality of mobility rooms on the basis of use requests for using the mobility rooms received from a plurality of external terminals,
the mobility rooms each comprising:
a room main body configured to form a living space;
a movement device configured to move the room main body freely;
a coupling part configured to allow an inside of the room main body and an inside of a building or another moving object to communicate with each other, enabling a user to move; and
a control unit configured to move the room main body autonomously using the movement device to cause the coupling part to reach a target coupling position with respect to the building or the another moving object on the basis of a movement request received from the management server.

5. The mobility room management system according to claim 4, further comprising a charge device configured to calculate a fee for using the mobility room for the user on the basis of a movement distance of the mobility room or a connection time between the mobility room and the building or the another moving object, and to charge the user the fee.

6. The mobility room management system according to claim 4, further comprising a payment status database configured to manage a payment status of the fee of each user, wherein
when accepting the use request from the external terminal, the management server is configured to acquire user identification information, to check the payment status of the fee indicated by the user identification information, and refuse the movement request if payment of the fee is overdue.

7. A management server configured to manage a plurality of mobility rooms configured to be able to move autonomously, the management server comprising:
a server communication unit configured to be able to communicate with an outside;
a room controller configured to control the plurality of mobility rooms; and
a room database configured to store data of the plurality of mobility rooms,
wherein the room controller is configured to
receive use requests for using the mobility rooms from a plurality of external terminals through the server communication unit,
select the mobility room that matches a use request by using the room database, and
transmit through the server communication unit a use instruction that corresponds to the use request, to a target mobility room which is the selected mobility room.

8. A building management system comprising:
a moving object side coupling part configured to communicate with an inside of a mobility room through a room side coupling part of the mobility room and to enable a user to come and go; and
a charge device configured to calculate a fee in accordance with a connection time between the room side coupling part and the moving object side coupling part and to charge the user the fee.
